(19) United States
(12) Patent Application Publication
(10) Pub. No.: US 2019/0079430 A1
(43) Pub. Date: Mar. 14, 2019

(54) OPTICAL SCANNING APPARATUS AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Yasushi Kuribayashi, Mishima Shizuoka (JP)

(21) Appl. No.: 15/702,953

(22) Filed: Sep. 13, 2017

(51) Int. Cl. B41J 2/385; G02B 26/12

(52) U.S. Cl. CPC G03G 15/0409; G03G 15/04036; G02B 26/127; G02B 26/125; G02B 26/123

(57) ABSTRACT

The optical scanning apparatus comprises a plurality of light sources; a light deflection member configured to deflect luminous flux from the plurality of the light sources to a main scanning direction; and a plurality of turning back mirrors configured to reflect luminous flux deflected in the main scanning direction by the light deflection member towards a scanning object moving in a sub-scanning direction. Adjustment mechanisms are selectively mounted in the turning back mirrors in which reflection directions with respect to incident directions of the luminous flux at the time of being developed excluding the other turning back mirrors in the middle to adjust postures and shapes thereof in a state in which optical paths from the plurality of the turning back mirrors to the corresponding scanning objects are fixed at the scanning object side which is an image surface.

### FIELD

Embodiments described herein relate generally to an optical scanning apparatus deflecting light from a light source in a main scanning direction to form an image on an image surface moving in a sub-scanning direction and an image forming apparatus provided with the optical scanning apparatus.

### BACKGROUND

Conventionally, as an image forming apparatus, for example, there is known a 4-tandem type color copying machine in which four photoconductive drums are arranged in parallel in a horizontal direction. This type of the color copying machine has, for example, a single polygon mirror arranged between a second photoconductive drum and a third photoconductive drum.

The color copying machine also has four light sources for forming electrostatic latent images on surfaces of the photoconductive drums, respectively. The four light sources are arranged, for example, two at the right side and two at the left side along a rotation direction of the polygon mirror to emit laser light based on image signals of respective colors subjected to color separation.

The laser light emitted from the two light sources at the left side is reflected by the same reflection surface of the polygon mirror and scanned in a main scanning direction by the rotation of the polygon mirror, and is guided respectively to two corresponding photoconductive drums at the left side via a plurality of reflection mirrors. On the other hand, the laser light emitted from the two light sources at the right side is reflected by another same reflection surface of the polygon mirror and scanned in the main scanning direction by rotation of the polygon mirror, and is guided respectively to two corresponding photoconductive drums at the right side via a plurality of reflection mirrors.

For example, the reflection mirrors of the same number of (for example, three) are arranged on an optical path from the reflection surface of the polygon mirror to the photoconductive drum of each color, and all the reflection mirrors are arranged bilaterally symmetrically with respect to the polygon mirror. In this case, a reflection direction of the laser light by the reflection mirror just before each photoconductive drum (e.g., the third reflection mirror at the most downstream side along an optical path of the laser light) is reversed at the left side and the right side of the polygon mirror.

Therefore, for example, in a case of correcting inclination in a sub-scanning direction of the laser light irradiated on the surface of each photoconductive drum by adjusting an angle of the reflection mirror at the most downstream side for reflecting the laser light toward each photoconductive drum, if the inclination in the sub-scanning direction on the surface of each photoconductive drum is desired to be corrected in the same direction in all the photoconductive drums, it is necessary to reverse a direction of tilting the reflection mirror at the left side and the reflection mirror at the right side of the polygon mirror.

If the reflection mirror is tilted to correct the inclination in the sub-scanning direction, an optical path length of the laser light reflected by the reflection mirror reaching the surface of the photoconductive drum becomes nonuniform along the main scanning direction, and distribution of the optical path length along the main scanning direction is generated. If the distribution along the main scanning direction is generated in the optical path length of the reflected light in this way, the length in the main scanning direction of a beam spot (scanning line) irradiated on the surface of the photoconductive drum changes. Specifically, if the reflection mirror is tilted to one side, the scanning line becomes longer, and if the reflection mirror is tilted to the other side, the scanning line becomes shorter.

As described above, if the inclination directions of the reflection mirror at the left side and the inclination direction of the reflection mirror at the right side of the polygon mirror are reversed to equalize the inclination in the sub-scanning direction, the spot on the surface of the photoconductive drum of the laser light reflected by one reflection mirror extends in the main scanning direction, whereas the spot on the surface of the photoconductive drum of the laser light reflected by the other reflection mirror shrinks in the main scanning direction. For this reason, color shift occurs along the main scanning direction at the time of superimposing images of respective colors.

Therefore, it is desired to develop an optical scanning apparatus and an image forming apparatus capable of effectively suppressing the shift in the main scanning direction and the sub-scanning direction of the light imaged on the image surface.

### DESCRIPTION OF THE DRAWINGS

FIG. 1 is a schematic diagram illustrating an image forming apparatus according to an embodiment;

FIG. 2 is a schematic diagram illustrating the peripheral structure of a photoconductive drum in the image forming apparatus in FIG. 1;

FIG. 3 is a block diagram illustrating the control system of the image forming apparatus in FIG. 1;

FIG. 4 is a schematic diagram illustrating the internal structure of an exposure unit in the image forming apparatus in FIG. 1;

FIG. 5 is a ray diagram in which an optical system of the exposure unit in FIG. 4 is developed in a plane;

FIG. 6A is a partially enlarged diagram in which main parts in FIG. 5 is partially enlarged;

FIG. 6B is a schematic diagram obtained by viewing the structure in FIG. 6A from an arrow F6B direction shown in FIG. 6A;

FIG. 7 is a schematic diagram illustrating a comparative example of an adjustment mechanism of the exposure unit in FIG. 4;

FIG. 8 is a ray diagram in which the optical system of the exposure unit in FIG. 7 is developed in a plane;

FIG. 9 is a graph illustrating a state in which inclination in a sub-scanning direction of a scanning line is corrected by the inclination adjustment mechanism in FIG. 7;

FIG. 10 is a graph illustrating color shift in a main scanning direction generated at the time of correcting inclination in the sub-scanning direction of the scanning line by the inclination adjustment mechanism in FIG. 7;

FIG. 11 is a graph illustrating a state in which a curvature in the sub-scanning direction of the scanning line is corrected by the curvature adjustment mechanism in FIG. 7;

FIG. 12 is a graph illustrating the color shift in the main scanning direction generated at the time of correcting the curvature in the sub-scanning direction of the scanning line by the curvature adjustment mechanism in FIG. 7;

FIG. 13 is a schematic diagram illustrating a layout of a first embodiment of the adjustment mechanism in the exposure unit in FIG. 4;

FIG. 14 is a schematic diagram illustrating the operation of the adjustment mechanism in FIG. 13;

FIG. 15 is a ray diagram in which an optical system of the exposure unit in FIG. 13 is developed in a plane;

FIG. 16 is a graph illustrating a state in which inclination in the sub-scanning direction of the scanning line is corrected by the inclination adjustment mechanism in FIG. 13;

FIG. 17 is a graph illustrating color shift in the main scanning direction generated at the time of correcting inclination in the sub-scanning direction of the scanning line by the inclination adjustment mechanism in FIG. 13;

FIG. 18 is a graph illustrating a state in which the curvature in the sub-scanning direction of the scanning line is corrected by the curvature adjustment mechanism in FIG. 13;

FIG. 19 is a graph illustrating color shift in the main scanning direction generated at the time of correcting the curvature in the sub-scanning direction of the scanning line by the curvature adjustment mechanism in FIG. 13;

FIG. 20 is a schematic diagram illustrating a layout according to a modification of the first embodiment;

FIG. 21 is a schematic diagram illustrating a layout of a second embodiment of the adjustment mechanism in the exposure unit in FIG. 4;

FIG. 22 is a schematic diagram illustrating an example of the curvature adjustment mechanism; and

FIG. 23 is a schematic diagram illustrating an example of the inclination adjustment mechanism.

### DETAILED DESCRIPTION

Hereinafter, an embodiment is described in detail with reference to the accompanying drawings.

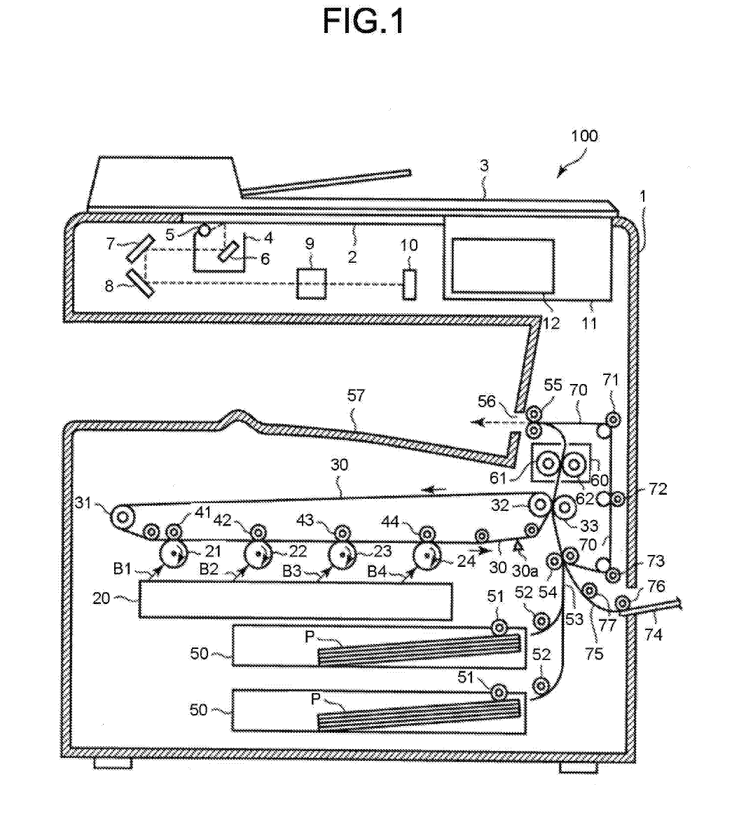

As shown in FIG. 1, a color copying machine 100 which is an embodiment of an image forming apparatus includes a transparent original table 2 for placing an original document at the top of a main body 1. A cover 3 is arranged above the original table 2 in an openable and closable manner. At the lower surface side of the original table 2, a carriage 4 is arranged, and an exposure lamp 5 is arranged on the carriage 4.

The carriage 4 reciprocates along the lower surface of the original table 2. The exposure lamp 5 exposes the original document on the original table 2 as the carriage 4 reciprocates. A CCD (Charge Coupled Device) 10 receives a reflected light image generated by this exposure via reflection mirrors 6, 7 and 8 and a variable magnification lens block 9. The CCD 10 outputs an image signal corresponding to the reflected light image from the original document.

A control panel 11 for setting operation conditions is arranged in the vicinity of the original table 2. The control panel 11 has a touch panel type liquid crystal display section 12.

The exposure unit 20 (optical scanning apparatus) receives an image signal output from the CCD 10. The exposure unit 20 separates colors of the image signal received from the CCD 10 into each color component. The exposure unit 20 guides laser light B1 (luminous flux) corresponding to the yellow image signal subjected to color separation to photoconductive drum 21 which is an image carrier (scanning object) for yellow color. The exposure unit 20 guides laser light B2 (luminous flux) corresponding to the magenta image signal subjected to the color separation to a photoconductive drum 22 which is an image carrier (scanning object) for magenta color. The exposure unit 20 guides laser light B3 (luminous flux) corresponding to the cyan image signal subjected to the color separation to the photoconductive drum 23 which is a image carrier (scanning object) for cyan color. The exposure unit 20 guides the laser light B4 (luminous flux) corresponding to the black image signal subjected to the color separation to the photoconductive drum 24 which is an image carrier (scanning object) for black color.

The photoconductive drums 21, 22, 23 and 24 are arranged in order in a substantially horizontal direction at certain intervals from the left to the right in FIG. 1. An intermediate transfer belt 30 (intermediate transfer medium) is arranged above these photoconductive drums 21, 22, 23 and 24. The intermediate transfer belt 30 is stretched over a driving roller 31 and a driven roller 32. The intermediate transfer belt 30 receives power from the driving roller 31 to rotate counterclockwise in FIG. 1.

Primary transfer rollers 41, 42, 43 and 44 (first transfer sections) are arranged in a vertically movable manner at positions facing the photoconductive drums 21, 22, 23 and 24, respectively. By pressing the intermediate transfer belt 30 against peripheral surfaces of the photoconductive drums 21, 22, 23 and 24 while rotating, the primary transfer rollers 41, 42, 43 and 44 transfers images on the photoconductive drums 21, 22, 23 and 24 onto the intermediate transfer belt 30.

At the downstream side of the photoconductive drum 24 for black color facing the intermediate transfer belt 30, registration sensors 30a and 30b for detecting resist patterns (not shown) of respective colors formed on the intermediate transfer belt 30. In FIG. 1, only one registration sensor 30a is shown. The registration sensors 30a and 30b are arranged apart from each other in a width direction of the intermediate transfer belt 30. The registration sensors 30a and 30b are arranged to detect corresponding resist patterns formed on the intermediate transfer belt 30 and to detect various shifts of images of respective colors.

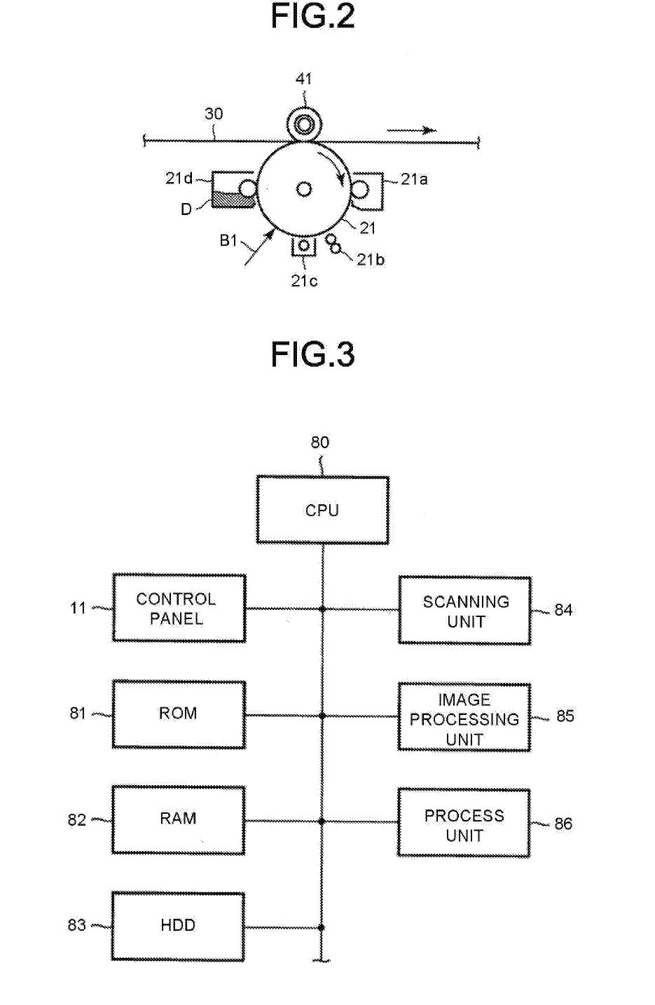

The structures of the photoconductive drum 21 and peripheral sections thereof are shown in FIG. 2.

As a developing module, a cleaner 21a, a charge removing lamp 21b, a charging unit 21c, and a developing unit 21d are arranged in order around the photoconductive drum 21. The cleaner 21a removes developers remaining on the surface of the photoconductive drum 21. The charge removing lamp 21b removes charge remaining on the surface of the photoconductive drum 21. The charging unit 21c charges the surface of the photoconductive drum 21 with electrostatic charge.

The surface of the photoconductive drum 21 charged by the charging unit 21c receives the laser light B1 emitted by the exposure unit 20. The laser light B1 forms an electrostatic latent image on the surface of the photoconductive drum 21. The developing unit 21d develops the electrostatic latent image on the surface of the photoconductive drum 21 by supplying yellow developer D to the surface of the photoconductive drum 21.

The peripheral sections of the other photoconductive drums 22, 23 and 24 have the same constitution. Therefore, the description thereof is omitted. The photoconductive drum 22, 23 and 24 are supplied with magenta developer D, cyan developer D, and black developer D respectively.

A plurality of sheet feed cassettes 50 is arranged under the exposure unit 20. These sheet feed cassettes 50 accommodate a large number of sheets P which are transfer mediums of different sizes. Pickup rollers 51 and sheet feed rollers 52 are arranged at positions corresponding to these sheet feed cassettes 50. Each pickup roller 51 picks up the sheets P in each sheet feed cassette 50 one by one. Each sheet feed roller 52 supplies the sheet P picked up by each pickup roller 51 to a conveyance path 53. The conveyance path 53 extends to an upper sheet discharge port 56 via the resist roller 54, the driven roller 32, a fixing unit 60, and a sheet discharge roller 55. The sheet discharge port 56 faces a sheet discharge tray 57.

A secondary transfer roller 33 (second transfer section) is arranged at a position opposed to the driven roller 32 across the intermediate transfer belt 30 and the conveyance path 53. The secondary transfer roller 33 transfers the image formed on the intermediate transfer belt 30 onto the sheet P fed from the resist roller 54. The secondary transfer roller 33, the intermediate transfer belt 30, the driving roller 31, the driven roller 32, and the primary transfer rollers 41, 42, 43 and 44 constitute a transfer module.

From the end of the conveyance path 53 to an upstream side position of the resist roller 54, a conveyance path 70 through which the front and back surfaces of the sheet P are inverted and the sheet P returns to the conveyance path 53 is arranged. The conveyance path 70 has sheet feed rollers 71, 72 and 73.

On the side wall of the main body 1, a manual feed tray 74 is detachably arranged. From the manual feed tray 74 to the upstream side position of the resist roller 54 in the conveyance path 53, a conveyance path 75 is arranged. A pickup roller 76 and a sheet feed roller 77 are arranged at positions corresponding to the conveyance path 75. The pickup roller 76 picks up the sheets on the manual feed tray 74 one by one. The sheet feed roller 77 supplies the sheet picked up by the pickup roller 76 to the resist roller 54.

The fixing unit 60 has a heat roller 61 and a pressure roller 62. The fixing unit 60 functions as a fixing module for fixing the image transferred onto the sheet P on the sheet P by heating the conveyed sheet Pat, for example, 100° C. with the heat roller 61.

A control circuit of the main body 1 is shown in FIG. 3.

A control panel 11, a ROM 81, a RAM 82, a hard disk drive (HDD) 83, a scanning unit 84, an image processing unit 85, and a process unit 86 are connected to a CPU 80 of a computer. The CPU 80 functions as a controller for controlling the operation of the image forming apparatus of the present embodiment.

In addition to the liquid crystal display section 12 of the touch panel type, the control panel 11 has numeric keys, a start key, a copy key for setting an image forming mode, a scan key for setting an image reading mode, and the like, which are not shown. The ROM 81 stores various control programs. The RAM 82 stores various data. The hard disk drive 83 stores image data. The scanning unit 84 includes the carriage 4, the exposure lamp 5, the reflection mirrors 6, 7 and 8, the variable magnification lens block 9, and the CCD 10, and optically scans and reads the image of the original document on the original table 2. The image processing unit 85 appropriately processes the read image of the scanning unit 84.

The process unit 86 includes the exposure unit 20, the photoconductive drums 21, 22, 23 and 24, the components of around each photoconductive drum in FIG. 2, the intermediate transfer belt 30, the driving roller 31, the driven roller 32, the primary transfer rollers 41, 42, 43 and 44, the secondary transfer roller 33, the conveyance path 53, the fixing unit 60, the conveyance path 70 and the like to form an image processed by the image processing unit 85 on the sheet P.

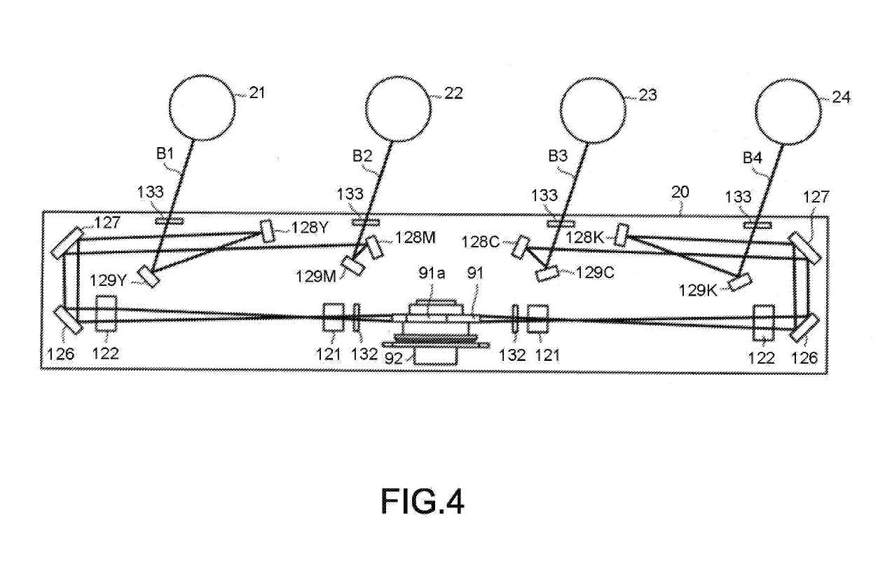

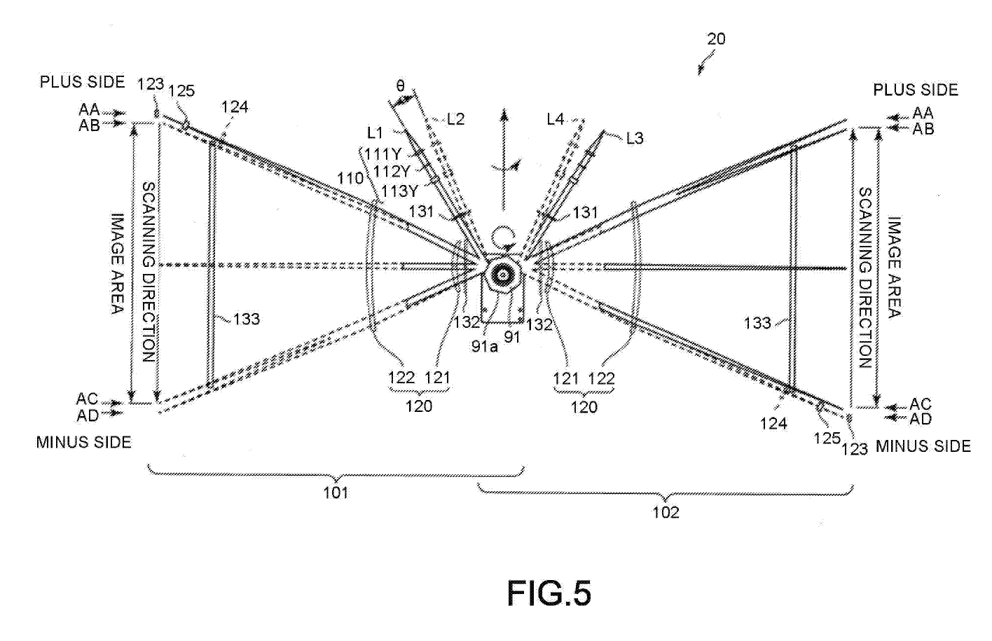

FIG. 4 is a schematic diagram illustrating the internal structure of the exposure unit 20. FIG. 5 is a ray diagram in which an optical system of the exposure unit 20 viewed from the photoconductive drums 21, 22, 23 and 24 side is developed in a plane along optical paths of the laser light B1, B2, B3 and B4. As shown in FIG. 1 and FIG. 4, the exposure unit 20 is arranged below the photoconductive drums 21, 22, 23 and 24 to face them.

The exposure unit 20 has, for example, a polyhedral mirror main body 91 (hereinafter, referred to as a polygon mirror 91) in which seven reflection surfaces are arranged in a regular polygonal shape. The polygon mirror 91 has a plurality of flat reflection surfaces 91a parallel to a rotation axis thereof. The plurality of the reflection surfaces 91a are arranged continuously on an outer periphery of the polygon mirror 91 along a rotation direction of the polygon mirror 91. The polygon mirror 91 functions as a light deflection member.

Furthermore, the exposure unit 20 has a motor 92 for rotating the polygon mirror 91 at a predetermined speed in a main scanning direction (arrow direction in FIG. 5). The motor 92 is arranged coaxially with the polygon mirror 91. For example, the polygon mirror 91 is integrally attached to the rotation axis of the motor 92.

The polygon mirror 91 is arranged between the second photoconductive drum 22 and the third photoconductive drum 23 from the left in FIG. 4 in such a posture that a rotation axis thereof is orthogonal to the rotation axis of each of photoconductive drums 21, 22, 23 and 24. As shown in FIG. 4, the photoconductive drum 21 for yellow color and the photoconductive drum 22 for magenta color are arranged at the left side of the polygon mirror 91 in FIG. 4, and the photoconductive drum 23 for cyan color and the photoconductive drum 24 for black color are arranged at the right side.

The exposure unit 20 has two scanning optical systems 101 and 102 at both sides (left side and right side in FIG. 5) of the single polygon mirror 91. Although the reflection angles of the laser light thereof are slightly different, the two scanning optical systems 101 and 102 have a structure that is generally bilaterally symmetrical.

The scanning optical system 101 at the left side in FIG. 5 of the polygon mirror 91 reflects the laser light B1 and B2 emitted from light sources L1 and L2 with the same reflection surface 91a of the polygon mirror 91 and scans in the main scanning direction to be guided to the two photoconductive drums 21 and 22 at the left side of FIG. 5. The scanning optical system 102 at the right side in FIG. 5 of the polygon mirror 91 reflects the laser light B3 and B4 emitted from light sources L3 and L4 with the same reflection surface 91a of the polygon mirror 91 and scans in the main scanning direction to be guided to the two photoconductive drums 23 and 24 at the right side of FIG. 5.

For example, the scanning optical system 101 at the left side of FIG. 5 has the light sources L1 and L2 which emit the laser light B1 and B2 towards the two photoconductive drums 21 and 22 at the left side of FIG. 5. Each of the light sources L1 and L2 is constituted by, for example, a laser diode, and the laser light B1 corresponding to the image signal of yellow color subjected to the color separation and the laser light B2 corresponding to the image signal of magenta color are respectively emitted.

The polygon mirror 91 reflects the laser light B1 and B2 emitted by the light sources L1 and L2 with the same reflection surface 91a and rotates to deflect (scan) the laser light B1 and B2 towards image surfaces arranged at predetermined positions, i.e., the outer peripheral surfaces of the corresponding photoconductive drums 21 and 22 at a predetermined linear velocity. By rotating the photoconductive drums 21 and 22 in the sub-scanning direction, electrostatic latent images corresponding to the image signals of the respective colors are formed on the outer peripheral surfaces of the photoconductive drums 21 and 22.

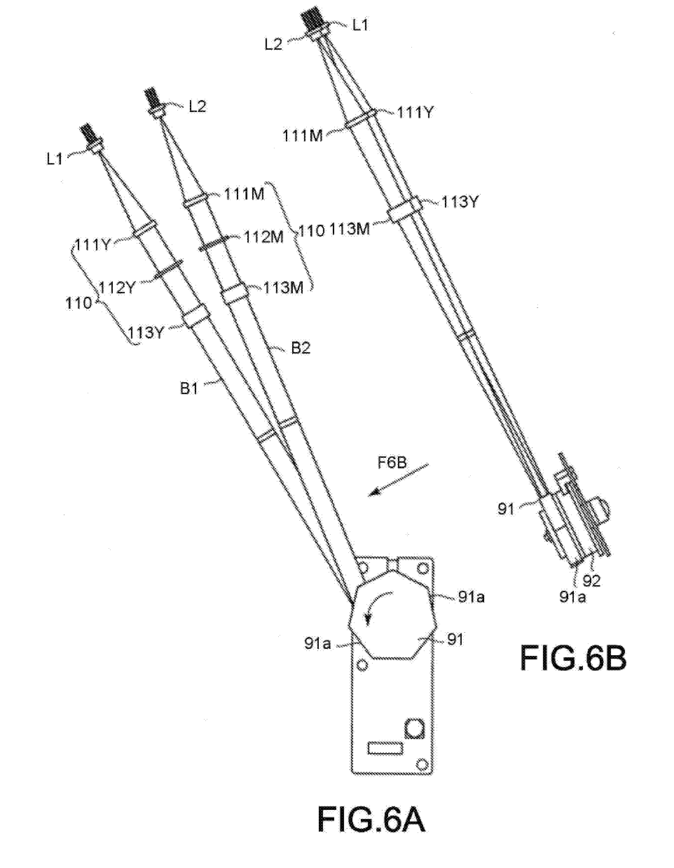

The two light sources L1 and L2 of the scanning optical system 101 are arranged at different angular positions along the rotation direction of the polygon mirror 91 (an arrow direction in FIG. 6A: counterclockwise direction) as shown in FIG. 6A. The light source L1 (yellow color) between the two light sources is arranged at the downstream side along the rotation direction of the polygon mirror 91, and the light source L2 (magenta color) is arranged at the upstream side along the rotation direction. As shown in FIG. 6B, the two light sources L1 and L2 are slightly deviated in a direction parallel to the rotation axis of the polygon mirror 91.

The pre-deflection optical system 110 is arranged between each of light sources L1 and L2 and the polygon mirror 91. Since the two light sources L1 and L2 have different angular positions facing the polygon mirror 91, independent pre-deflection optical systems 110 can be arranged in the optical paths of the respective laser light B1 and B2.

Two pairs of pre-deflection optical systems 110 respectively corresponding to the light sources L1 and L2 include finite focus lenses 111Y and 111M which give predetermined convergence to the laser light B1 and B2 emitted from the light sources L1 and L2, diaphragms 112Y and 112M which give an arbitrary sectional beam shape to the laser light B1 and B2 passing through the finite focus lenses 111Y and 111M, and cylinder lenses 113Y and 113M for further giving predetermined convergence in the sub-scanning direction to the laser light B1 and B2 passing through the diaphragms 112Y and 112M. The pre-deflection optical system 110 adjusts the sectional beam shapes of the laser light B1 and B2 emitted from the light sources L1 and L2 to predetermined shapes and guides the laser light B1 and B2 to the reflection surface 91a of the polygon mirror 91.

Between the polygon mirror 91 and the image surfaces, in other words, the outer peripheral surfaces of the photoconductive drums 21 and 22, a post-deflection optical system 120 shown in FIG. 4 and FIG. 5 is arranged. The post-deflection optical system 120 includes fθ lenses 121 and 122 (two-piece combination imaging lenses) for optimizing the shapes and positions on the image surfaces of the laser light B1 and B2 deflected (scanned) by the polygon mirror 91.

Furthermore, in order to adjust the horizontal synchronization of the laser light B1 and B2 passing through the fθ lenses 121 and 122, the post-deflection optical system 120 includes an optical detector 123 for horizontal synchronization for detecting a part thereof at an end at the scanning start side (scanning position AA) of the laser light B1. FIG. 5 shows that the laser light B1 is developed in a plane, and a turning back mirror 124 for turning the laser light B1 to the optical detector 123 is provided on the optical path from the fθ lens 122 to the optical detector 123. Further, between the turning back mirror 124 and the optical detector 123, an optical path correction element 125 is arranged to guide the laser light B1 reflected towards the optical detector 123 by the turning back mirror 124 to the detection surface of the optical detector 123.

As shown in FIG. 4, the post-deflection optical system 120 has two turning back mirrors 126 and 127 for halfway turning the laser light B1 and B2 of the respective color components emitted from the fθ lenses 121 and 122 in common. Furthermore, the post-deflection optical system 120 includes a plurality of turning back mirrors 128Y, 129Y, 128M and 129M that individually guide the laser light B1 and B2 turned by the two turning back mirrors 126 and 127 toward the corresponding photoconductive drums 21 and 22, respectively.

A first cover glass 131 exists between the pre-deflection optical system 110 and the polygon mirror 91, and a second cover glass 132 exists between the polygon mirror 91 and the post-deflection optical system 120. If the polygon mirror 91 is boxed, the first cover glass 131 functions as an entrance of the laser light and the second cover glass 132 functions as an exit as a countermeasure against wind noise at the time the polygon mirror 91 rotates. Third cover glasses 133 exist between the turning back mirrors 129Y and 129M and the photoconductive drums 21 and 22 and function as exits of the laser light from a housing of the exposure unit 20.

On the other hand, the scanning optical system 102 at the right side of FIG. 5 has the light sources L3 and L4 which emit the laser light B3 and B4 respectively towards the two photoconductive drums 23 and 24 at the right side of FIG. 5. Each of the light sources L3 and L4 is composed of, for example, a laser diode, and the laser light B3 corresponding to the image signal of cyan color subjected to the color separation and the laser light B4 corresponding to the image signal of black color are emitted.

The polygon mirror 91 reflects the laser light B3 and B4 emitted by the light source L3 and L4 with the same reflection surface 91a (the reflection surface different from that described above reflecting the laser light B1 and B2) and rotates, and in this way, the laser light B3 and B4 is deflected (scanned) at a predetermined linear velocity towards the image surfaces arranged at predetermined positions, in other words, the outer peripheral surfaces of the corresponding photoconductive drums 23 and 24. The photoconductive drums 23 and 24 rotate in the sub-scanning direction, and in this way, electrostatic latent images corresponding to the image signals of the respective colors are formed on the outer peripheral surfaces of the photoconductive drums 23 and 24.

The two light sources L3 and L4 of the scanning optical system 102 are arranged at different angular positions along the rotation direction of the polygon mirror 91, similarly to the light sources L1 and L2 of the scanning optical system 101 described above. Between the two light sources, the light source L3 (cyan color) is arranged at the upstream side along the rotation direction of the polygon mirror 91, and the light source L4 (black color) is arranged at the downstream side along the rotation direction. The two light sources L3 and L4 are slightly deviated in a direction parallel to the rotation axis of the polygon mirror 91.

The pre-deflection optical system 110 is arranged between each light source L3 and L4 and the polygon mirror 91. The post-deflection optical system 120 is arranged between the polygon mirror 91 and the image surface, in other words, the outer peripheral surfaces of the photoconductive drums 23 and 24. The pre-deflection optical system 110 and the post-deflection optical system 120 have substantially the same structure as those of the scanning optical system 101 described above. Therefore, in this case, detailed description of the pre-deflection optical system 110 and the post-deflection optical system 120 of the scanning optical system 102 at the right side is omitted by appending “C” and “K” as appropriate to the reference numerals of the similarly functioning components.

In this case, a direction in which the laser light B1, B2, B3 and B4 is deflected (scanned) by the polygon mirror 91 (a rotation axis direction of the photoconductive drums 21, 22, 23 and 24) is defined as the “main scanning direction”, and a rotation axis direction of the polygon mirror 91 which is a deflector is defined as the “sub-scanning direction”. Therefore, the main scanning direction is perpendicular to an optical axis direction of each optical system and the rotation axis direction of the polygon mirror 91, respectively.

In the present embodiment, since the scanning optical system 101 and the scanning optical system 102 are arranged at the left and right sides of the polygon mirror 91, if the polygon mirror 91 is rotated in a certain direction, a scanning direction of the photoconductive drums 21 and 22 by the scanning optical system 101 and a scanning direction of the photoconductive drums 23 and 24 by the scanning optical system 102 are reversed. Specifically, if it is assumed that an upper side in FIG. 5 is plus, and a lower side therein is minus, the scanning optical system 101 at the left side in FIG. 5 scans the image surface from a plus side to a minus side, and the scanning optical system 102 at the right side in FIG. 5 scans the image surface from the minus side to the plus side.

In order to match a writing timing of the main scanning direction of the laser light B1, B2, B3 and B4 in the scanning optical system 101 and the scanning optical system 102, the optical detectors 123 for horizontal synchronization are necessarily arranged at the upstream side in the main scanning direction of the scanning optical systems 101 and 102. Therefore, in the present embodiment, as shown in FIG. 5, the optical detector 123 for horizontal synchronization is arranged at a scanning position AA at the upstream side in the main scanning direction at the plus side of the image area in the scanning optical system 101, and in the scanning optical system 102, the optical detector 123 for horizontal synchronization is arranged at a scanning position AD at the upstream side in the main scanning direction at the minus side of the image area.

In the exposure unit 20 described above, if there are assembling errors in a plurality of optical components that reflect or transmit the laser light B1, B2, B3 and B4 of respective colors, “inclination” and “curvature” in the sub-scanning direction occur on the scanning lines formed by exposure of the laser light on the surfaces of the photoconductive drums 21, 22, 23 and 24. If each optical component has the “inclination” or the “curvature”, the “inclination” or the “curvature” also occurs in the scanning line formed on the surface of the photoconductive drum. Alternatively, if the photoconductive drums 21, 22, 23 and 24 are aslant mounted with respect to the color copying machine 100, the scanning lines formed on the surfaces of the photoconductive drums tilt. In this way, if the “inclination” and the “curvature” occur in the scanning line on the image surface, an image defect such as color shift occurs in the output image. Therefore, it is necessary to correct the “inclination” and the “curvature” of the scanning line.

(Comparative Example)

For correcting the “inclination” and “curvature” in the sub-scanning direction of the scanning line on the surface of the photoconductive drum, for example, a method is conceivable to adjust shapes and angles of turning back mirrors 129Y, 129M, 129C and 129K (hereinafter, also collectively referred to as turning back mirror 129) included in the post-deflection optical system 120 which reflect the laser light B1, B2, B3 and B4 reflected by the polygon mirror 91 toward the photoconductive drums 21, 22, 23 and 24. In this way, by adjusting the turning back mirrors 129Y, 129M, 129C and 129K arranged at the most downstream side (immediately before the photoconductive drums 21, 22, 23 and 24 of respective colors) along a transmission direction of the laser light B1, B2, B3 and B4 of respective colors, a sensitivity of adjustment can be increased, and highly accurate adjustment is enabled.

In a case of correcting the “inclination” of the scanning line, for example, one end in the main scanning direction of the corresponding turning back mirror 129 is set at a fulcrum and the other end thereof is shifted in a direction perpendicular to the reflection surface by an inclination adjustment mechanism (not shown) provided at a back side of the turning back mirror 129. In a case of correcting the “curvature” of the scanning line, the turning back mirror 129 is curved by shifting a center in a longitudinal direction of the turning back mirror 129 in a direction orthogonal to the reflection surface by a curvature adjustment mechanism (not shown) provided at the back side of the turning back mirror 129. At least one of the inclination adjustment mechanism and the curvature adjustment mechanism may be arranged, or an adjustment mechanism with both functions may be arranged.

For example, in a case of correcting the “inclination” in the sub-scanning direction of the scanning line on the image surface (surface of the photoconductive drum), it is necessary to align the directions in which the inclination in the sub-scanning direction for all the laser light B1, B2, B3 and B4 in the same direction. In this case, as described above, if the inclination adjustment mechanism is arranged in the turning back mirrors 129Y, 129M, 129C and 129K at the most downstream side in the apparatus constitution in which the scanning optical systems 101 and 102 are arranged at the left and right sides of the polygon mirror 91, inclination directions of the turning back mirrors 129Y and 129M are opposite to those of the turning back mirrors 129C and 129K.

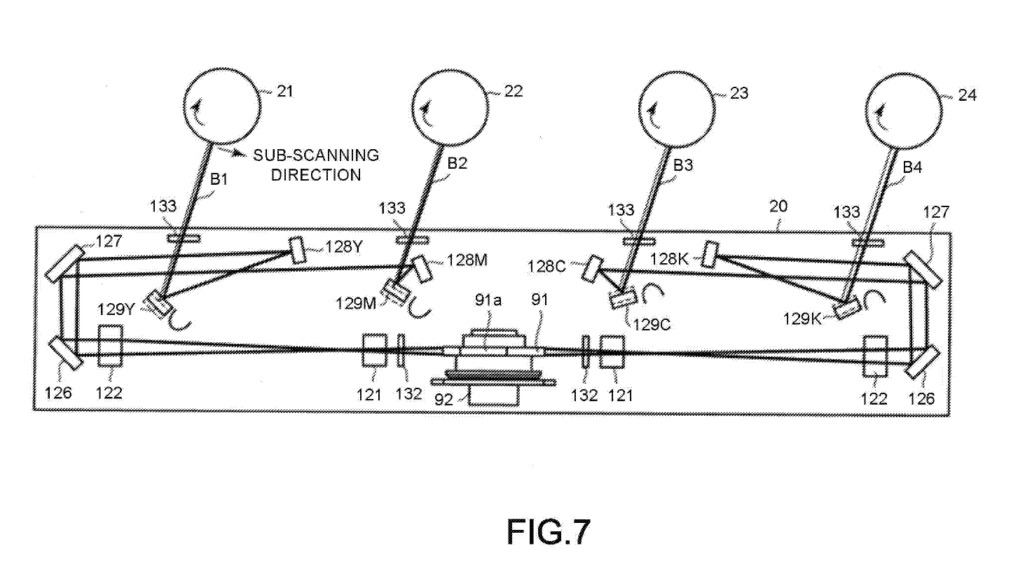

For example, as shown in FIG. 7, as a concrete example, one ends of the turning back mirrors 129Y and 129M at the rear side of the paper surface (the main scanning direction plus side) are used as fulcrums, and the other ends thereof at the front side of the paper surface (the main scanning direction minus side) are shifted to the back side, and in this way, the turning back mirrors 129Y and 129M are positioned at positions shown by dotted lines in FIG. 7. Then, one ends at the rear side of the paper surface of the turning back mirrors 129C and 129K are used as the fulcrums, and the other ends at the front side of the paper surface thereof is shifted to the reflection surface side, and in this way, the turning back mirrors 129C and 129K are arranged at the positions shown by the dotted lines the FIG. 7. Thereby, the inclination of the scanning lines formed on the surfaces of the photoconductive drums 21, 22, 23 and 24 can be corrected by being aligned at the same side of the sub-scanning direction (downstream side in the rotation direction of each photoconductive drum).

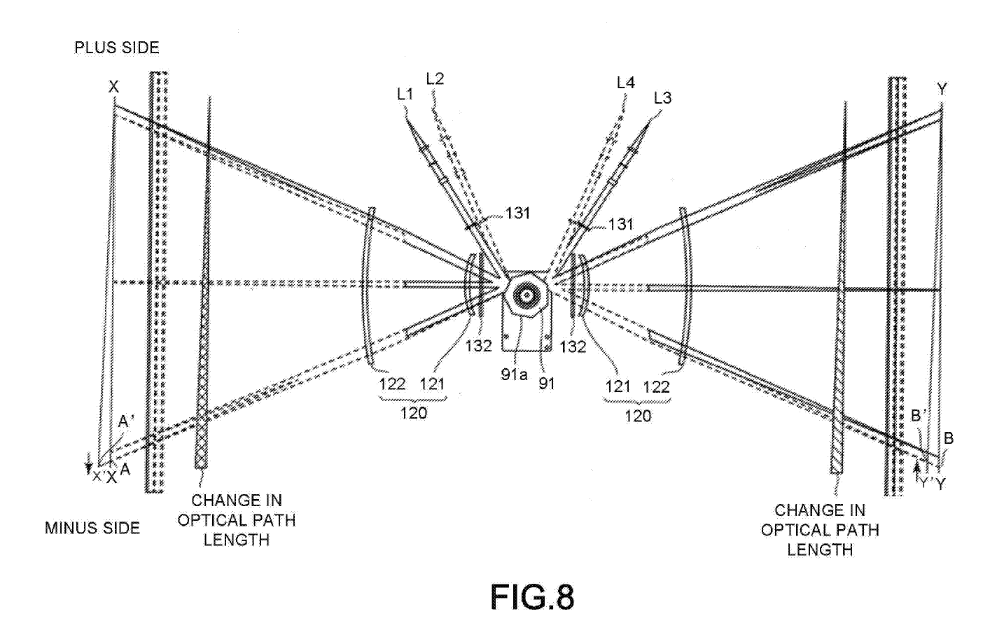

However, if the other ends of the turning back mirrors 129Y and 129M are shifted to the position shown by the dotted lines in FIG. 7 and tilted, the optical path lengths of the laser light B1 and B2 from the reflection surfaces of the turning back mirrors 129Y and 129M to the surfaces of the corresponding photoconductive drums 21 and 22 gradually increase from the rear side to the front side of the paper surface. Then, the scanning lines exposed to the surfaces of the photoconductive drums 21 are 22 are shifted from X-X line to X-X′ line in FIG. 8. In this case, the scanning line at the minus side in the main scanning direction gradually increases in an advancing direction of the laser light B1 and B2, and the exposure position at the minus side of the scanning line is shifted from A to A′. As a result, a slight color shift occurs at the minus side of the main scanning direction.

Furthermore, if the other ends of the turning back mirrors 129C and 129K are shifted to the positions indicated by the dotted lines in FIG. 7 and tilted, the optical path lengths of the laser light B3 and B4 from the reflection surfaces of the turning back mirrors 129C and 129K to the surfaces of the corresponding photoconductive drums 23 and 24 gradually become shorter from the rear side to the front side of the paper surface. Then, the scanning lines exposed to the surfaces of the photoconductive drums 23 are 24 are shifted from Y-Y line to Y-Y′ line in FIG. 8. In this case, the scanning line at the minus side in the main scanning direction gradually decreases in an advancing direction of the laser light B3 and B4, and the exposure position at the minus side of the scanning line is shifted from B to B′. As a result, a slight color shift occurs at the plus side of the main scanning direction.

As described above, according to the present comparative example, a new color shift occurs in the main scanning direction by correcting the “inclination” of the sub-scanning direction of the scanning line in the same direction. According to the present comparative example, since the color shift in the main scanning direction is different at the left and right sides of the polygon mirror 91, the color shift at the time of superposing the images of respective colors expands in the main scanning direction.

On the other hand, the same is true in a case of correcting the “curvature” of the scanning line in the same direction. For example, the centers in the longitudinal direction of the two turning back mirrors 129Y and 129M at the left side are curved in a direction to protrude toward the back side, and the centers in the longitudinal direction of the two turning back mirrors 129C and 129K at the right side are curved in the reverse direction to protrude toward the reflection surface side. In this case, the color shift toward the center from both ends in the main scanning direction of the scanning lines formed on the surfaces of the photoconductive drums 21 and 22 at the left side occurs, and the color shift toward both ends from the center in the main scanning direction of the scanning lines formed on the surfaces of the photoconductive drums 23 and 24 at the right side occurs.

In other words, as in the present comparative example, if the inclination adjustment mechanism and the curvature adjustment mechanism are arranged in the turning back mirrors 129Y, 129M, 129C and 129K at most downstream side, in a case in which the correction directions of the “inclination” and the “curvature” of the scanning line are aligned to the same side in the sub-scanning direction, the color shift in the main scanning direction of the scanning lines formed on the surfaces of the photoconductive drums 21 and 22 at the left side and the color shift in the main scanning direction of the scanning lines formed on the surfaces of the photoconductive drums 23 and 24 occur in mutually opposite directions. Therefore, according to the present comparative example, the color shift in the main scanning direction is increased by correcting the color shift in the sub-scanning direction.

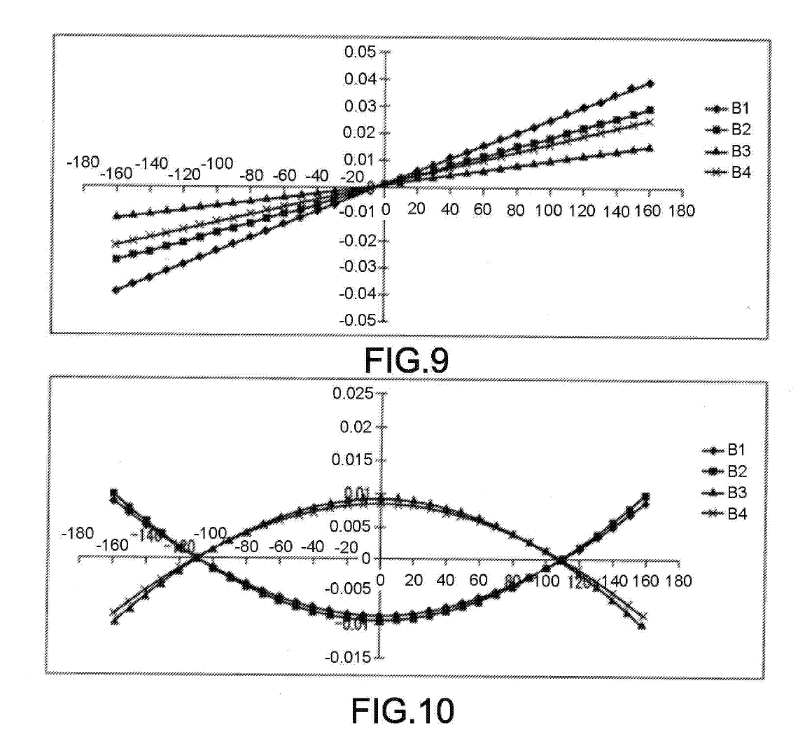

FIG. 9 is a graph illustrating an inclination correction state in the sub-scanning direction of the scanning line at the time of tilting the turning back mirrors 129Y, 129M, 129C and 129K according to the present comparative example, and FIG. 10 is a graph illustrating the color shift in the main scanning direction generated at the time of tilting the turning back mirrors 129Y, 129M, 129C and 129K according to the present comparative example. FIG. 10 shows a state in which the color shift in the main scanning direction is corrected to zero at predetermined positions (positions of ±110) in the main scanning direction, and shows a state in which the magnification in the main scanning direction is corrected and parallel shift is performed.

According to this, if the inclination correction directions in the sub-scanning direction are aligned as in the present comparative example, the color shift in the main scanning direction occurs in the opposite direction at the left and right sides of the polygon mirror, and in particular, the color shift increases at the center and both ends in the main scanning direction.

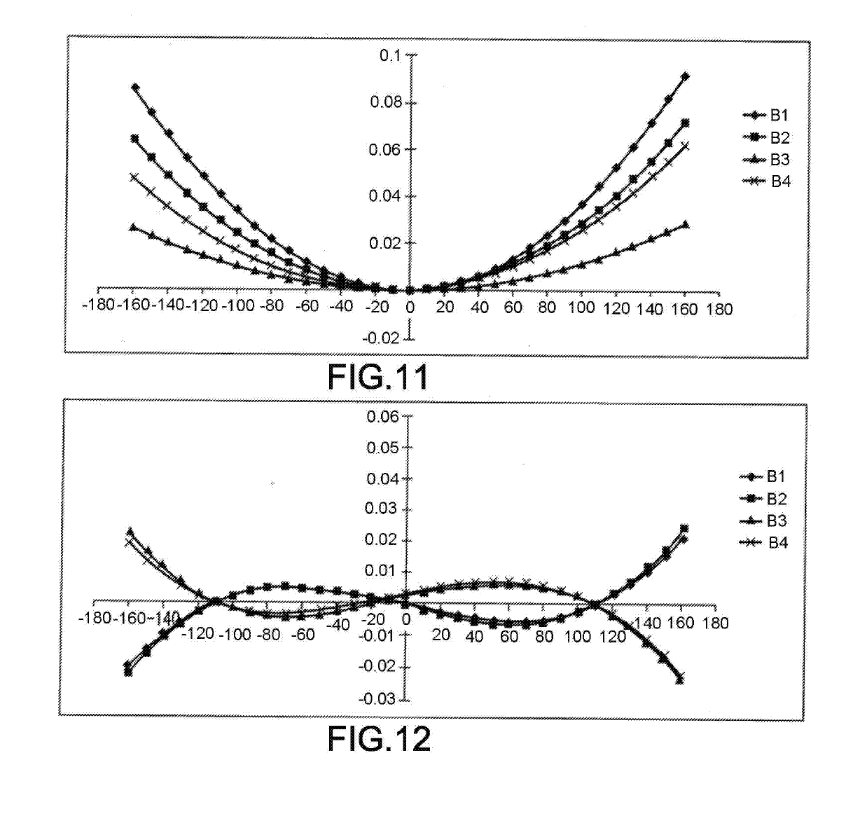

FIG. 11 is a graph illustrating a curvature correction state in the sub-scanning direction of the scanning line at the time the turning back mirrors 129Y, 129M, 129C and 129K are curved as in the present comparative example, FIG. 12 is a graph illustrating the color shift in the main scanning direction occurring at the time the turning back mirrors 129Y, 129M, 129C and 129K are curved as in the present comparative example. FIG. 12 shows a state in which the color shift in the main scanning direction is corrected to zero at predetermined positions (the positions of ±110) in the main scanning direction, and a state in which the magnification in the main scanning direction is corrected and the parallel shift is performed.

According to this, if the curvature correction directions of the sub-scanning direction are aligned as in the present comparative example, the color shift in the main scanning direction occurs in the opposite directions at the left and right sides of the polygon mirror, and in particular, the color shift increases at both ends in the main scanning direction.

### First Embodiment

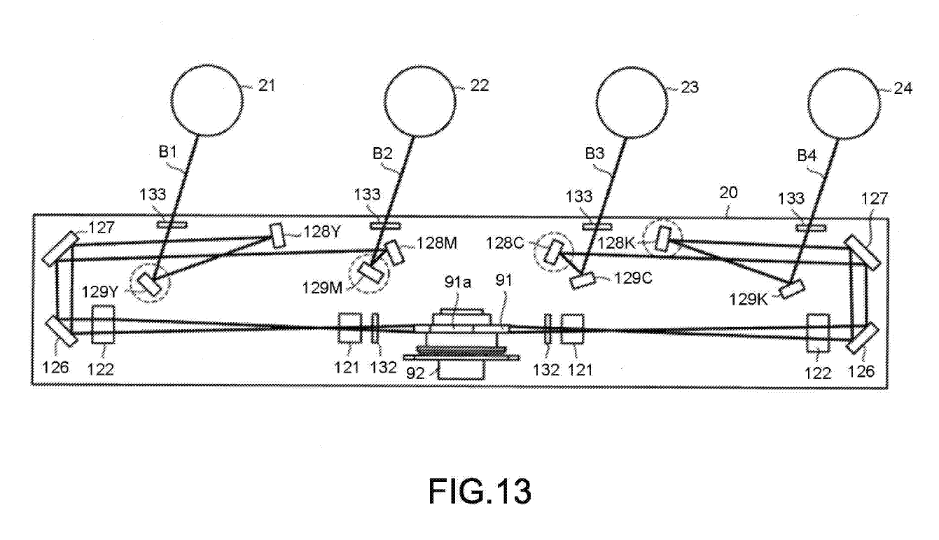

On the other hand, in the first embodiment, the above-mentioned inclination adjustment mechanism and the curvature adjustment mechanism (hereinafter, also collectively referred to as the adjustment mechanism in some cases) are mounted in the turning back mirrors 129Y, 129M, 128C and 128K surrounded by dotted lines in FIG. 13. These four turning back mirrors 129Y, 129M, 128C and 128K are turning back mirrors in which the reflection directions with respect to the incident directions of the laser light B1, B2, B3 and B4 are the same direction in the sub-scanning direction at the time of being developed excluding the turning back mirrors 129C and 129K in the middle in a state in which the optical paths from the turning back mirrors 129Y, 129M, 128C and 128K to the corresponding photoconductive drums 21, 22, 23 and 24 are fixed at the photoconductive drum side which is the image surface.

By attaching the adjustment mechanism to the turning back mirrors 129Y, 129M, 128C and 128K of “same direction” in this way, for example, in a case of correcting the inclination of the scanning lines exposed on the surfaces of the photoconductive drums 21, 22, 23 and 24 of respective colors at the same side in the sub-scanning direction, unlike the comparative example described above, the direction in which the turning back mirrors 129Y and 129M are tilted and the direction in which the turning back mirrors 128C and 128K are tilted can be set as the same direction.

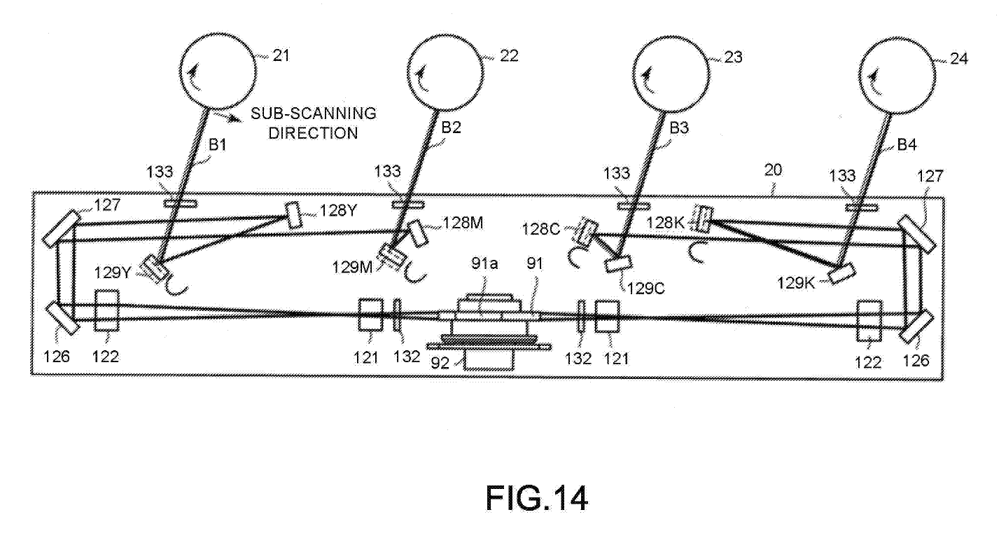

For example, as shown in FIG. 14, as a concrete example, one ends of the turning back mirrors 129Y and 129M at the rear side of the paper surface (the main scanning direction plus side) are used as fulcrums, and the other ends (the main scanning direction minus side) at the front side of the paper surface are shifted to the back side, and in this way, the turning back mirrors 129Y and 129M are placed at the positions indicated by dotted lines in FIG. 14. Then, one ends of the turning back mirrors 128C and 128K at the rear side of the paper surface are used as fulcrums, and the other ends at the front side of the paper surface are shifted to the back side, and in this way, the turning back mirrors 128C and 128K are placed at the positions indicated by dotted lines in FIG. 14. Thereby, the inclination of the scanning lines formed on the surface of the photoconductive drums 21, 22, 23 and 24 can be corrected by being aligned to the same side of the sub-scanning direction (downstream side in the rotation direction of each photoconductive drum)

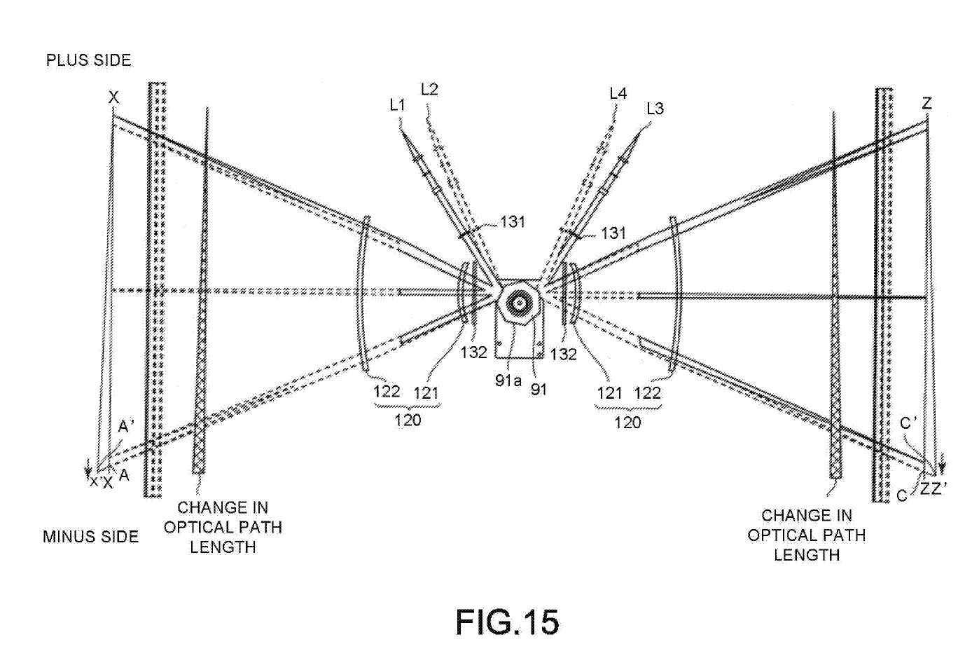

If the other ends of the turning back mirrors 129Y and 129M are shifted to the positions indicated by the dotted lines in FIG. 14 and tilted, the optical path lengths of the laser light B1 and B2 from the reflection surfaces of the turning back mirrors 129Y and 129M to the surfaces of the corresponding photoconductive drums 21 and 22 gradually increase from the rear side to the front side of the paper surface, respectively. Then, the scanning lines exposed on the surfaces of the photoconductive drums 21 and 22 are shifted from X-X to X-X′ in FIG. 15. In this case, the minus side in the main scanning direction of the scanning line gradually increases in the advancing direction of the laser light B1 and B2, and the exposure position at the minus side of the scanning line is shifted from A to A′. As a result, the slight color shift occurs at the minus side in the main scanning direction.

If the other ends of the turning back mirrors 128C and 128K are shifted to the positions indicated by the dotted lines in FIG. 14 and tilted, the optical path lengths of the laser light B3 and B4 from the reflection surfaces of the turning back mirrors 128C and 128K to the surfaces of the corresponding photoconductive drums 23 and 24 gradually increase from the rear side to the front side of the paper surface, respectively. Then, the scanning lines exposed on the surfaces of the photoconductive drums 23 and 24 are shifted from Z-Z to Z-Z′ in FIG. 15. In this case, the minus side in the main scanning direction of the scanning line gradually increases in the advancing direction of the laser light B3 and B4, and the exposure position at the minus side of the scanning line is shifted from C to C′. As a result, the slight color shift occurs at the minus side in the main scanning direction.

According to the present embodiment, if the “inclination” in the sub-scanning direction of the scanning line is corrected in the same direction, although the slight color shift occurs in the main scanning direction at the left and right sides of the polygon mirror 91, as the directions of color shift at the left and right sides of the polygon mirror 91 are the same direction (minus side of the scanning line), the color shift in the main scanning direction is unlikely to occur at the time of superimposing the images of respective colors. In other words, according to the present embodiment, it is possible to output a good color image without the color shift in the main scanning direction and the sub-scanning direction.

Furthermore, the same is true in the case of correcting the “curvature” of the scanning line to the same direction. For example, the centers in the longitudinal direction of the two turning back mirrors 129Y and 129M at the left side are curved in a direction to protrude toward the back side, and the centers of the two turning back mirrors 128C and 128K at the right side are curved in the same direction to protrude toward the back side. In this case, the slight color shift toward the center from both ends in the main scanning direction of the scanning lines formed on the surfaces of the photoconductive drums 21 and 22 at the left side occurs, and the slight color shift toward both ends from the center in the main scanning direction of the scanning lines formed on the surfaces of the photoconductive drums 23 and 24 at the right side occurs.

According to the present embodiment, if the “curvature” of the scanning line is corrected in the same direction of the sub-scanning direction, although the slight color shift occurs in the main scanning direction at the left and right sides of the polygon mirror 91, as the directions of color shift are the same direction (direction from both ends to the center of the scanning line), the color shift in the main scanning direction is unlikely to occur at the time of superimposing the images of respective colors. In other words, according to the present embodiment, it is possible to output a good color image without the color shift in the main scanning direction and the sub-scanning direction even if the “curvature” of the scanning line is corrected.

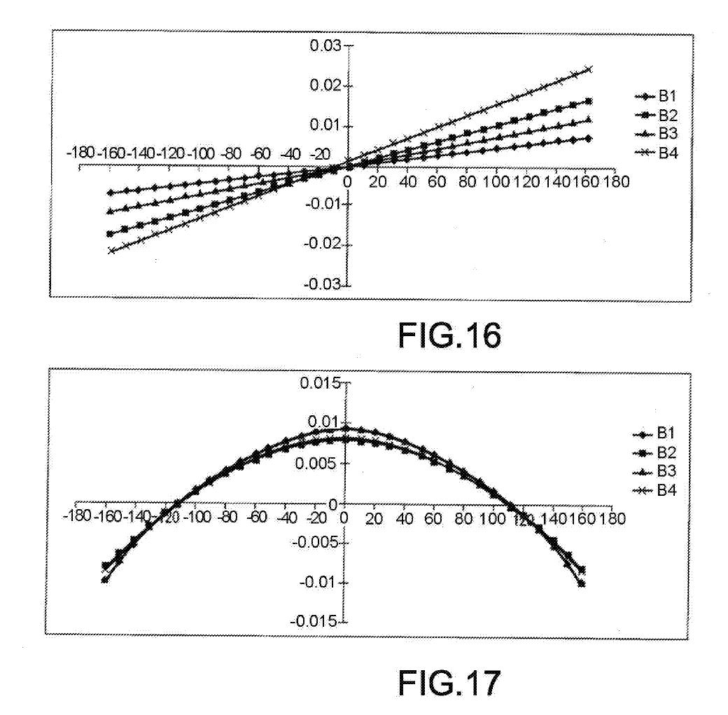

FIG. 16 is a graph illustrating the inclination correction state in the sub-scanning direction of the scanning line at the time the turning back mirrors 129Y, 129M, 128C and 128K are tilted as in the present embodiment, and FIG. 17 is a graph illustrating the color shift in the main scanning direction occurring at the time the turning back mirrors 129Y, 129M, 128C and 128K are inclined as in the present embodiment. FIG. 17 shows a state in which the color shift in the main scanning direction is corrected to zero at predetermined positions (the positions of ±110) in the main scanning direction, and a state in which the magnification of the main scanning direction is corrected and the parallel shift is performed.

As is known from FIGS. 16 and 17, according to the present embodiment, if the inclination correction direction in the sub-scanning direction of the scanning line is aligned in the same direction for each color, as described above, the slight color shift in the main scanning direction at the left and right sides of the polygon mirror occurs in the same direction. In other words, according to the present embodiment, if the inclination in the sub-scanning direction of the scanning lines exposed on the surfaces of the photoconductive drums 21, 22, 23 and 24 is corrected, a good color image can be output without generating relative color shift along the main scanning direction on the superimposed image.

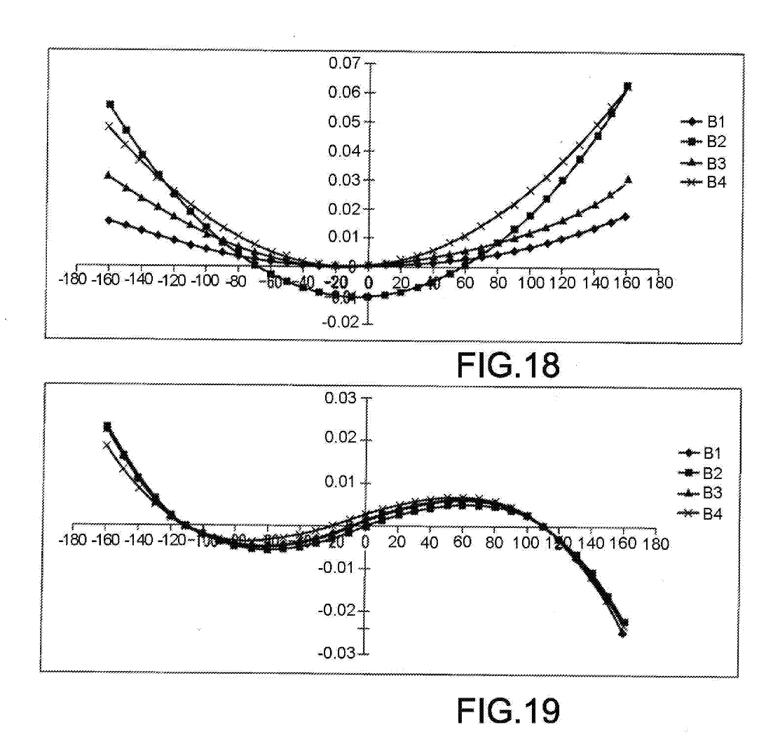

FIG. 18 is a graph illustrating the curvature correction state of the sub-scanning direction of the scanning line at the time the turning back mirrors 129Y, 129M, 128C and 128K are curved as in the present embodiment, FIG. 19 is a graph illustrating the color shift in the main scanning direction occurring at the time the turning back mirrors 129Y, 129M, 128C 128K are curved as in the present embodiment. FIG. 19 shows a state in which the color shift in the main scanning direction is corrected to zero at predetermined positions (the positions of ±110) in the main scanning direction, and a state in which the magnification of the main scanning direction is corrected and the parallel shift is performed.

As is known from FIGS. 18 and 19, according to the present embodiment, if the curvature correction direction in the sub-scanning direction of the scanning line is aligned in the same direction for each color, as described above, the slight color shift in the main scanning direction at the left and right sides of the polygon mirror occurs in the same direction. In other words, according to the present embodiment, if the curvature in the sub-scanning direction of the scanning lines exposed on the surfaces of the photoconductive drums 21, 22, 23 and 24 is corrected, a good color image can be output without generating relative color shift along the main scanning direction on the superimposed image.

(Modification)

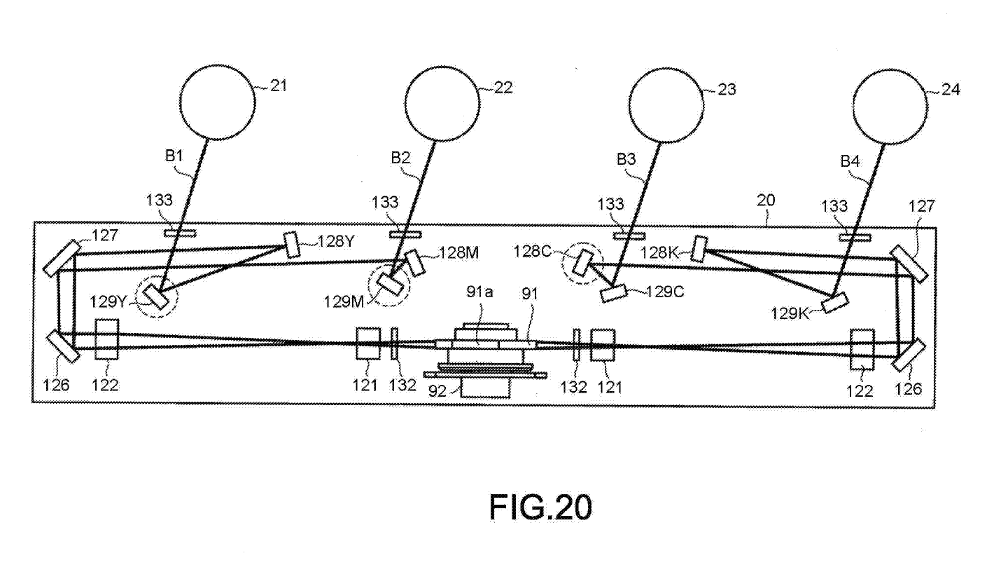

FIG. 20 shows a modification of the first embodiment described above.

In a case of correcting the “inclination” or the “curvature” of the scanning line by the exposure unit 20, or in a case of correcting the “inclination” or the “curvature” of the scanning line in the color copying machine 100, it is conceivable to set a color as a correction reference, and correct the “inclination” or the “curvature” of the laser light corresponding to the remaining colors so as to match the colors. In this case, it is unnecessary to provide the inclination adjustment mechanism and the curvature adjustment mechanism in the optical member for transmitting the laser light of the reference color.

In the modification in FIG. 20, black is used as a reference color. In this case, the inclination adjustment mechanism and the curvature adjustment mechanism may be provided only for yellow color, magenta color and cyan color, and the inclination adjustment mechanism and the curvature adjustment mechanism may be provided in the turning back mirrors 129Y, 129M and 128C. Therefore, according to the present modification, the inclination adjustment mechanism and the curvature adjustment mechanism provided in the turning back mirror 128K in the first embodiment can be omitted, and the apparatus constitution can be simplified accordingly, thereby reducing the manufacturing cost of the apparatus.

### Second Embodiment

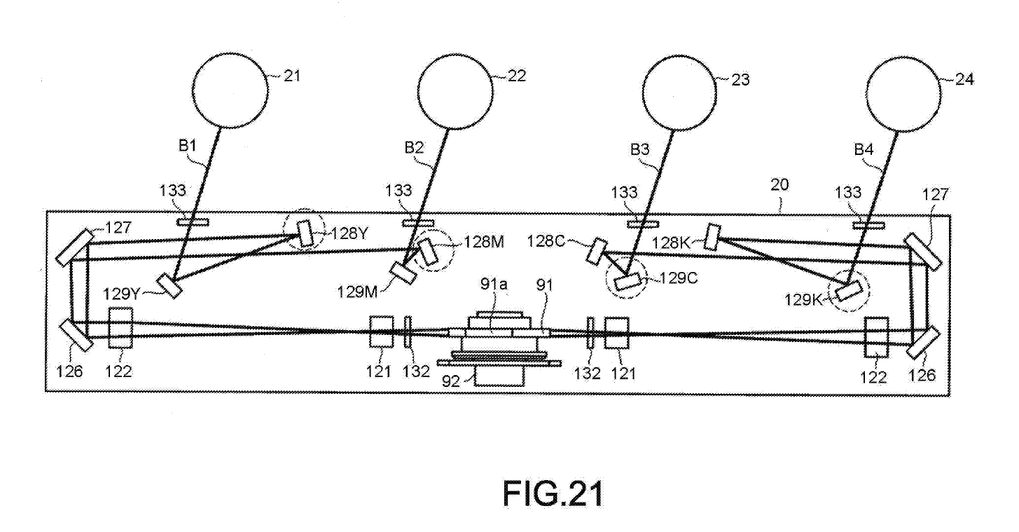

FIG. 21 shows the second embodiment.

In the first embodiment described above, the inclination adjustment mechanism and the curvature adjustment mechanism are provided in the turning back mirrors 129Y and 129M for yellow color and magenta color, and the inclination adjustment mechanism and the curvature adjustment mechanism are provided in the turning back mirrors 128C and 128K for cyan color and black color. However, in the present embodiment, the inclination adjustment mechanism and the curvature adjustment mechanism are provided in the turning back mirrors 128Y and 128M for yellow color and magenta color, and the inclination adjustment mechanism and the curvature adjustment mechanism are provided in the turning back mirrors 129C and 129K for cyan color and black color.

Therefore, the effect similar to that of the above-described first embodiment can also be achieved in the present embodiment.

According to the above-described embodiments, in a case of applying the inclination adjustment mechanism and the curvature adjustment mechanism provided in the turning back mirror of each color to align the directions in which the “inclination” and the “curvature” in the sub-scanning direction on the image surface (the surface of the photoconductive drum) are corrected, by aligning the direction of the color shift in the main scanning direction caused by the optical path difference generated by changing the postures of the turning back mirrors to perform the inclination correction, or by the optical path difference generated by changing the shapes of the turning back mirrors to perform the curvature correction, it is possible to output an image with less color shift in the sub-scanning direction and the main scanning direction.

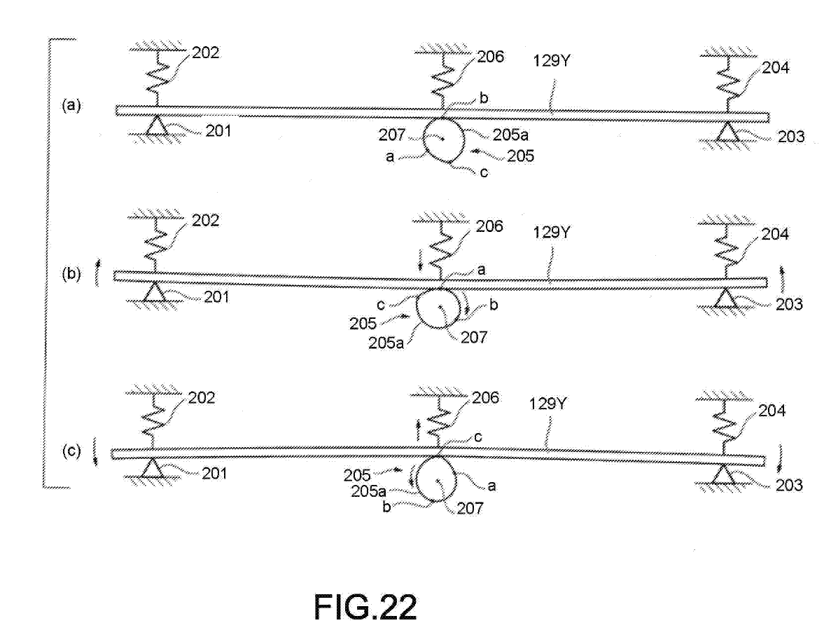

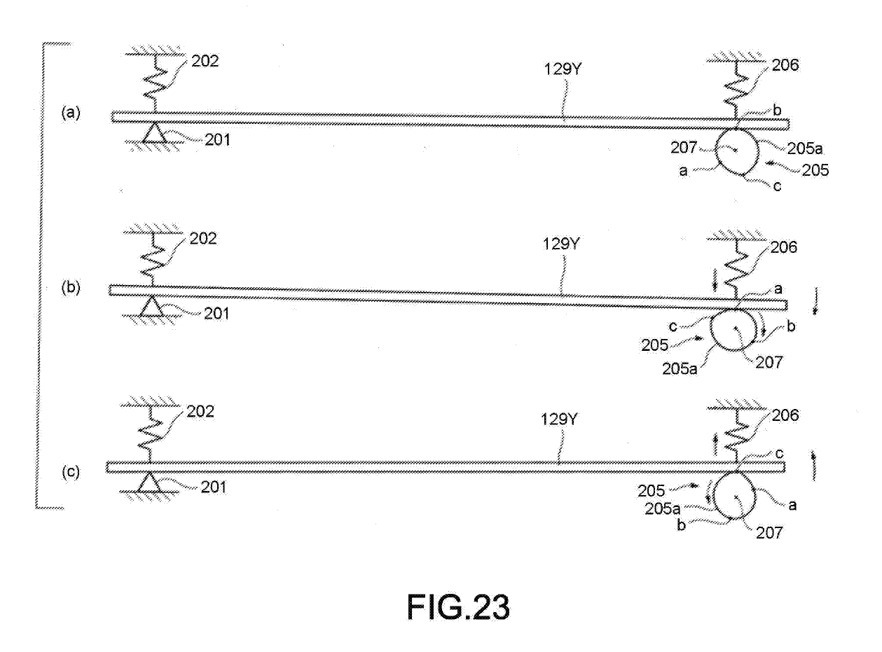

FIG. 22 is a schematic diagram illustrating an example of the curvature adjustment mechanism, and FIG. 23 is a schematic diagram illustrating an example of the inclination adjustment mechanism.

As shown in FIG. 22, the curvature adjustment mechanism includes, for example, a support member 201 for supporting the one end (the left end in FIG. 22) in the longitudinal direction of the turning back mirror 129Y from the back side and a pressing member 202 which presses one end of the turning back mirror 129Y towards the support member 201 from the front side. The curvature adjustment mechanism includes a support member 203 for supporting the other end (the right end in FIG. 22) in the longitudinal direction of the turning back mirror 129Y from the back side and a pressing member 204 which presses the other end of the turning back mirror 129Y towards the support member 203 from the front side. Furthermore, the curvature adjustment mechanism further includes an adjustment cam 205 arranged to face the center in the longitudinal direction at the back side of the turning back mirror 129Y and a pressing member 206 for pressing the center of the turning back mirror 129Y towards the adjustment cam 205 from the front side.

The adjustment cam 205 rotates around a rotation axis 207. A peripheral surface 205a of the adjustment cam 205 is a cam surface in which a distance from the rotation axis 207 to the peripheral surface 205a changes in a peripheral direction. A point on the peripheral surface 205a at which the distance from the rotation axis 207 to the peripheral surface 205a is shortest is “a”. A point on the peripheral surface 205a at which the distance from the rotation axis 207 to the peripheral surface 205a is longest is “c”. A point on the peripheral surface at which the distance from the rotation axis 207 to the peripheral surface 205a is an intermediate value is “b”.

If the adjustment cam 205 rotates to a position shown in FIG. 22(a), the peripheral surface 205a of the adjustment cam 205 abuts against the back surface of the turning back mirror 129Y at the point “b”. In this state, the contact points of the support members 201 and 203 arranged at the both ends of the turning back mirror 129Y to the turning back mirror 129Y and the contact point of the adjustment cam 205 to the turning back mirror 129Y are aligned in a straight line. In other words, in this state, the turning back mirror 129Y is held in a straight state without curvature.

If the adjustment cam 205 is rotated to the position shown in FIG. 22(b), the peripheral surface 205a of the adjustment cam 205 abuts against the back surface of the turning back mirror 129Y at the point “a”. In this state, the center of the turning back mirror 129Y is pressed by the pressing member 206 facing the adjustment cam 205, and the center of the turning back mirror 129Y is pressed to the back side by setting the supporting members 201 and 203 arranged at both ends of the turning back mirror 129Y as a fulcrum. In other words, in this state, the turning back mirror 129Y is curved in a state in which the center is recessed.

If the adjustment cam 205 is rotated to the position shown in FIG. 22(c), the peripheral surface 205a of the adjustment cam 205 abuts against the back surface of the turning back mirror 129Y at the point “c”. In this state, the pressing member 206 facing the adjustment cam 205 shrinks, the center of the turning back mirror 129Y is pressed by the adjustment cam 205 from the back side, and the center of the turning back mirror 129Y is pressed to the front side by setting a pressing point by the pressing members 202 and 204 arranged at both ends of the turning back mirror 129Y as a fulcrum. In other words, in this state, the turning back mirror 129Y is curved in a shape in which the center is convex.

As shown in FIG. 23, the curvature adjustment mechanism includes, for example, the support member 201 for supporting one end (the left end in FIG. 22) in the longitudinal direction of the turning back mirror 129Y from the back side and a pressing member 202 which presses the one end of the turning back mirror 129Y towards the support member 201 from the front side. The inclination adjustment mechanism further includes an adjustment cam 205 arranged to face the back side nearby the other end in the longitudinal direction of the turning back mirror 129Y and a pressing member 206 for pressing the other end of the turning back mirror 129Y towards the adjustment cam 205 from the front side. The structure and function of the adjustment cam 205 are the same as those of the curvature adjustment mechanism described above.

If the adjustment cam 205 is rotated to the position shown in FIG. 23(a), the peripheral surface 205a of the adjustment cam 205 abuts against the back surface of the turning back mirror 129Y at the point “b”. In this state, the contact point of the support member 201 arranged at the one end of the turning back mirror 129Y to the turning back mirror 129Y and the contact point of the adjustment cam 205 to the turning back mirror 129Y are at the same height. In other words, in this state, the turning back mirror 129Y is held in a straight state without inclination.

If the adjustment cam 205 is rotated to the position shown in FIG. 23(b), the peripheral surface 205a of the adjustment cam 205 abuts against the back surface of the turning back mirror 129Y at the point “a”. In this state, the other end of the turning back mirror 129Y is pressed by the pressing member 206 facing the adjustment cam 205, and the right end of the turning back mirror 129Y in FIG. 23 is moved downward by setting the supporting member 201 arranged at one end of the turning back mirror 129Y as a fulcrum. In other words, in this state, the right end of the turning back mirror 129Y in FIG. 23 is tilted downward.

If the adjustment cam 205 is rotated to the position shown in FIG. 23(c), the peripheral surface 205a of the adjustment cam 205 abuts against the back surface of the turning back mirror 129Y at the point “c”. In this state, the pressing member 206 facing the adjustment cam 205 shrinks, the other end of the turning back mirror 129Y is pressed by the adjustment cam 205 from the back side, and the right end of the turning back mirror 129Y in FIG. 23 is moved upward by setting the supporting member 201 arranged at one end of the turning back mirror 129Y as a fulcrum. In other words, in this state, the right end of the turning back mirror 129Y in FIG. 23 is tilted upward.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An optical scanning apparatus, comprising:
a plurality of light sources;
a light deflection member configured to deflect luminous flux from the plurality of light sources in a main scanning direction;
a plurality of turning back mirrors configured to reflect luminous flux deflected in the main scanning direction by the light deflection member towards a scanning object moving in a sub-scanning direction; and
adjustment mechanisms selectively mounted on the plurality of turning back mirrors in which reflection directions with respect to incident directions of the luminous flux at a time of being developed excluding other turning back mirrors in a middle to adjust postures and shapes thereof in a state in which optical paths from the plurality of tho turning back mirrors to the corresponding scanning objects are fixed at the scanning object side which is an image surface,
wherein an adjustment mechanism of the adjustment mechanisms comprises a cam on a first side of a turning back mirror and a pressing member on a second side of the turning back mirror, and wherein the first side is opposite the second side.

2. The optical scanning apparatus according to claim 1, wherein
the adjustment mechanisms comprise at least one of an inclination adjustment mechanism for adjusting inclination in the sub-scanning direction of turning back mirrors in which the reflection directions are the same direction and a curvature adjustment mechanism for adjusting curvature in the sub-scanning direction of the turning back mirrors in which the reflection directions are the same direction.

3. The optical scanning apparatus according to claim 1, wherein
the adjustment mechanisms comprise an optical detector and optical path correction element.

4. The optical scanning apparatus according to claim 1, wherein
each adjustment mechanism is mounted on a respective back non-reflective side of each turning back mirror.

5. The optical scanning apparatus according to claim 2, wherein
the inclination adjustment mechanism and the curvature adjustment mechanism are mounted on a back non-reflective side of the turning back mirrors.

6. An image forming apparatus, comprising:
an optical scanning apparatus configured to guide first to fourth luminous flux based on image signals to first to fourth scanning objects via a light deflection member and a plurality of turning back mirrors to form respective latent images on each scanning objects of the first to fourth scanning objects; and
an image forming section configured to develop the latent images and transfer them onto a transfer medium, wherein
the optical scanning apparatus further comprises:
a plurality of light sources;
the light deflection member configured to deflect the first to fourth luminous flux from the plurality of light sources in a main scanning direction;
the plurality of turning back mirrors are configured to reflect luminous flux deflected in the main scanning direction by the light deflection member towards a scanning object of the first to fourth scanning objects that is moving in a sub-scanning direction; and
adjustment mechanisms selectively mounted on the plurality of turning back mirrors in which reflection directions with respect to incident directions of the luminous flux at a time of being developed excluding other turning back mirrors in a middle to adjust postures and shapes thereof in a state in which optical paths from the plurality of the turning back mirrors to the corresponding scanning objects are fixed at the scanning object side which is an image surface, and
wherein an adjustment mechanism of the adjustment mechanisms comprises a cam on a first side of a turning back mirror and a pressing member on a second side of the turning back mirror, and wherein the first side is opposite the second side.

7. The image forming apparatus according to claim 6, wherein
the adjustment mechanisms comprise at least one of an inclination adjustment mechanism for adjusting inclination in the sub-scanning direction of turning back mirrors in which the reflection directions are the same direction and a curvature adjustment mechanism for adjusting curvature in the sub-scanning direction of the turning back mirrors in which the reflection directions are the same direction.

8. The image forming apparatus according to claim 6, wherein
the adjustment mechanisms comprise an optical detector and optical path correction element.

9. The image forming apparatus according to claim 6, wherein
each adjustment mechanism is mounted on a respective back non-reflective side of each turning back mirror.

10. The image forming apparatus according to claim 7, wherein
the inclination adjustment mechanism and the curvature adjustment mechanism are mounted on a back non-reflective side of the turning back mirrors.

11. An image forming apparatus, comprising:
an optical scanning apparatus configured to guide first to fourth luminous flux based on image signals to first to fourth scanning objects via a light deflection member and a plurality of turning back mirrors to form a latent image on each scanning object;
a plurality of developing sections configured to develop latent images on the scanning objects;
a first transfer section configured to overlap a plurality of images developed in the plurality of developing sections on an intermediate transfer medium to transfer them; and
a second transfer section configured to transfer the plurality of images transferred onto the intermediate transfer medium onto a transfer medium, wherein
the optical scanning apparatus further comprises:
a plurality of light sources;
the light deflection member configured to deflect the first to fourth luminous flux from the plurality of light sources in a main scanning direction;
the plurality of turning back mirrors configured to reflect luminous flux deflected in the main scanning direction by the light deflection member towards a scanning object of the first to fourth scanning objects that is moving in a sub-scanning direction; and
adjustment mechanisms selectively mounted on the plurality of turning back mirrors in which reflection directions with respect to incident directions of the luminous flux at a time of being developed excluding other turning back mirrors in the middle to adjust postures and shapes thereof in a state in which optical paths from the plurality of the turning back mirrors to the corresponding scanning objects are fixed at the scanning object side which is an image surface, and
wherein an adjustment mechanism of the adjustment mechanisms comprises a cam on a first side of a turning back mirror and a pressing member on a second side of the turning back mirror, and wherein the first side is opposite the second side.

12. The image forming apparatus according to claim 11, wherein
the adjustment mechanisms comprise at least one of an inclination adjustment mechanism for adjusting inclination in the sub-scanning direction of turning back mirrors in which the reflection directions are the same direction and a curvature adjustment mechanism for adjusting curvature in the sub-scanning direction of the turning back mirrors in which the reflection directions are the same direction.

13. The image forming apparatus according to claim 11, wherein
the adjustment mechanisms comprise an optical detector and optical path correction element.

14. The image forming apparatus according to claim 11, wherein
each adjustment mechanism is mounted on a respective back non-reflective side of each turning back mirror.

15. The image forming apparatus according to claim 12, wherein
the inclination adjustment mechanism and the curvature adjustment mechanism are mounted on a back non-reflective side of the turning back mirrors.

16. The optical scanning apparatus according to claim 1, wherein a first set of turning back mirrors of the plurality of turning back mirrors are located at a first portion of the optical scanning apparatus and a second set of turning back mirrors of the plurality of turning back mirrors are located at a second portion of the optical scanning apparatus, and wherein the adjustment mechanism adjusts the first set of turning back mirrors to a first position and the second set of turning back mirrors to a second position, and wherein the first position is different from the second position.

17. The optical scanning apparatus according to claim 1, wherein the cam touches a central portion between a first set of turning back mirrors of the plurality of turning back mirrors and a second set of turning back mirrors of the plurality of turning back mirrors.

18. The image forming apparatus according to claim 6, wherein a first set of turning back mirrors of the plurality of turning back mirrors are located at a first portion of the image scanning apparatus and a second set of turning back mirrors of the plurality of turning back mirrors are located at a second portion of the image scanning apparatus, and wherein the adjustment mechanism adjusts the first set of turning back mirrors to a first position and the second set of turning back mirrors to a second position different from the first position.

19. The image forming apparatus according to claim 6, wherein the cam touches a central portion between a first set of turning back mirrors of the plurality of turning back mirrors and a second set of turning back mirrors of the plurality of turning back mirrors.

20. The optical scanning apparatus according to claim 11,
wherein the cam contacts a central portion between a first set of turning back mirrors of the plurality of turning back mirrors and a second set of turning back mirrors of the plurality of turning back mirrors,
wherein the first set of turning back mirrors are located left of the center portion and the second set of turning back mirrors are located right of the center portion, and
wherein the adjustment mechanism adjusts the first set of turning back mirrors to a first position and the second set of turning back mirrors to a second position different from the first position.
